(19) United States
(12) Patent Application Publication
(10) Pub. No.: US 2026/0134334 A1
(43) Pub. Date: May 14, 2026

(54) DYNAMIC DEPLOYMENT OF MACHINE LEARNING MODELS IN MULTI-NODE EDGE INFRASTRUCTURES

(71) Applicant: INTERNATIONAL BUSINESS MACHINES CORPORATION, Armonk, NY (US)

(72) Inventors: Alecio Pedro Delazari Binotto, Munich (DE); Sagar Tayal, Ambala City (IN); Maja Curic, Munich (DE)

(21) Appl. No.: 18/943,361

(22) Filed: Nov. 11, 2024

(51) Int. Cl. G06N 20/00; H04W 24/08

(52) U.S. Cl. CPC G06N 20/00; H04W 24/08

(57) ABSTRACT

Allocating a machine learning model (MLM) on edge infrastructure includes detecting processing capabilities of a plurality of edge nodes of an edge infrastructure. The processing capabilities of the plurality of edge nodes are compared with profiles for a plurality of machine learning models (MLMs) and processing requirements of a predetermined task. An MLM is selected from the plurality of MLMs for executing on one or more edge nodes of the plurality of edge nodes based on the comparing. An edge node from the plurality of edge nodes is selected to run the MLM selected based on the comparing. The MLM selected is deployed via a data communication network to the edge node selected.

### BACKGROUND

This disclosure relates to edge computing and, more particularly, to deploying large language models (LLMs) and other machine learning models (MLMs) in edge infrastructures having multiple edge nodes.

Edge computing is a distributed computing framework that brings computation and data storage closer to the sources of the data. With edge computing, data is processed locally on an edge-located device (edge node) such as a server or other type of node. Only data that specifically needs to be processed at a central location needs to be transmitted via a data communication network to the central location. An advantage of edge computing is the reduction of latency, enhanced bandwidth usage, and improved response times compared to more conventional cloud computing in which data is processed at a centralized location such as a datacenter or on one or more cloud-based servers.

### SUMMARY

In one or more embodiments, a method of allocating a machine learning model (MLM) includes detecting processing capabilities of a plurality of edge nodes of an edge infrastructure. The processing capabilities of the plurality of edge nodes are compared with profiles for a plurality of machine learning models (MLMs) and processing requirements of a predetermined task. An MLM is selected from the plurality of MLMs for executing on one or more edge nodes of the plurality of edge nodes based on the comparing. An edge node from the plurality of edge nodes is selected to run the MLM selected based on the comparing. The MLM selected is deployed via a data communication network to the edge node selected.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example architecture of an edge-infrastructure model deployment and monitoring (MDM) framework.

FIG. 2 illustrates an example method of operation of the MDM framework of FIG. 1.

FIG. 3 illustrates certain operative aspects of the MDM framework of FIGS. 1 and 2.

FIG. 4 illustrates an example of a computing environment that is capable of implementing the MDM framework of FIGS. 1 and 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to employ the features described in virtually any appropriately detailed structure. Further, the terms and phrases used within this disclosure are not intended to be limiting, but rather to provide an understandable description of the features described.

This disclosure relates to edge computing and, more particularly, to deploying MLMs, which may include LLMs, on edge infrastructures having multiple edge nodes. Notwithstanding the advantages of edge computing, edge infrastructures often have limited computing power and network capacity, which poses a challenge when deploying MLMs, especially LLMs, which are typically complex and have high computing-resource requirements. The edge nodes of an edge infrastructure are often unable to effectively and efficiently support MLM deployments, owing to limitations in processing power, memory capacity, storage availability, energy efficiency, and the like.

Another challenge relates to the diverse requirements for different edge environments. Edge infrastructure refers to the physical and virtual resources required to support edge computing, including hardware (e.g., servers, storage devices), software platforms and tools, and network connections for linking edge nodes to one another and to a central datacenter or cloud. The edge environment encompasses not only the edge infrastructure but additional elements as well, including deployment locations (e.g., retail stores, factories, offices), operational conditions (e.g., limited space, power, cooling facilities), and tasks—that is, the specific applications and workloads that run on the edge nodes. Each edge environment may have a different infrastructure setup and diverse requirements depending on factors such as the specific tasks and operational conditions.

Adding to the complexity in deploying MLMs on an edge infrastructure is the dynamic nature of edge environments. Traditional approaches to MLM deployment typically do not adapt to the dynamic nature of edge computing environments.

In accordance with the inventive arrangements described herein, methods, systems, and computer program products are provided that are capable of deploying, monitoring, and, as needed, redeploying MLMs on an edge infrastructure in a manner that enhances resource use and performance of the edge nodes.

“Performance,” as used herein, refers to any measure of the edge nodes'speed, efficiency, and/or resource usage executing an MLM in response to user inputs. Performance, in various embodiments, may be measured according to different measurements. For example, one measure of performance is the speed by which MLM-related tasks executed by the edge nodes are performed. Another performance measure, for example, is the throughput of the edge nodes in performing MLM-related tasks. If the MLM is an LLM, for example, the performance may be measured in terms of tokens (e.g., words) streamed per unit of time. The edge nodes of the edge infrastructure are operatively coupled to one another via a data communication network, and performance of the network may be measured, for example, in terms of latency and/or network congestion that may influence latency. In certain embodiments, an infrastructure-wide measure of performance is Pareto efficiency, in which a given MLM deployment is Pareto-efficient if, and only if, there is no alternative MLM deployment that improves the performance (e.g., execution or throughput) of one edge node without adversely affecting the performance of one or more of the edge infrastructure's other edge nodes.

The inventive arrangements disclosed herein assess and prioritize the deployment of MLMs so that the deployment aligns with the unique characteristics of the specific edge environment. The alignment is one that is most likely to optimize resource usage and computing performance of the edge nodes forming an edge infrastructure.

In certain embodiments of the inventive arrangements disclosed herein, the processing capabilities of the edge nodes are detected. An MLM is selected from among a collection of candidate MLMs. The selection is based on the respective capabilities of each candidate MLM relative to a predetermined task. The MLM selected is deployed via the data communication network to one or more edge nodes that are selected from among all the edge nodes forming the edge infrastructure. The one or more selected edge nodes are selected based on comparing a profile specifying processing requirements of the selected MLM with the processing capabilities of all the edge nodes.

The edge nodes of an edge infrastructure may be operatively coupled with one another via a data communication network to form an edge infrastructure. Accordingly, in certain embodiments, the processing capabilities of the edge nodes may be determined based on metrics associated with each of the network-connected edge nodes and automatically generated with respect to physical components of each of the edge nodes.

Among the technological improvements of the inventive arrangements over conventional technology is deployment of an MLM on an edge infrastructure in conjunction with detecting the processing capabilities of each edge node of the edge infrastructure. For example, based on such metrics, assessing deployment of the MLM may include factoring in the CPU and/or GPU processing capacity available for running the MLM, available memory, energy usage, and other factors affecting the efficaciousness and efficiency of running the MLM on an edge node. One technical advantage of detecting the processing capabilities of the edge nodes is that the assessment enables the deployment of the MLM on one or more edge nodes that, in a technical sense, are best suited for running the MLM. Rather than an ad hoc deployment, as with many conventional approaches, a technical advantage of the inventive arrangements disclosed herein is a deployment that is most likely to optimize resource usage and performance of the one or more edge nodes on which the MLM is deployed.

Another distinct technical advantage stems from detecting the processing capabilities of all the edge nodes of the edge infrastructure, not merely one(s) in which the MLM is deployed. As a result, the processing requirements of the MLM are compared with the processing capabilities of all the edge nodes, which may preclude the inefficiencies that may arise from deploying the MLM to an edge node whose processing capabilities exceed those needed to run the MLM. Deploying the MLM to an edge node that is limited or incapable of running the MLM leads to a less-than-optimal performance or failed execution of the MLM, but conversely, deploying the MLM to edge node whose processing capabilities exceed those needed to run the MLM likely wastes compute resources and may lead to suboptimal performance of the edge infrastructure. This occurs if the MLM could be run on a different edge node, which would free up the edge node whose processing capabilities exceed those needed to run the MLM to handle a more resource-intensive task. The inventive arrangements disclosed herein operate to ensure that processing capabilities of the edge node match the processing requirements of the deployed MLMs.

In certain embodiments, both the detecting of processing capabilities of the edge nodes and the deploying the selected MLM to one or more of the edge nodes are performed in real time. Thus, the inventive arrangements disclosed herein enable the intermittent or continuous, real-time monitoring of the performance of the edge nodes, including the one or more edge nodes selected to run the MLM. The MLM may be redeployed, including in real time, to one or more different edge nodes in response to detecting that the performance is less than a predetermined threshold. A technical advantage is the ability to maintain the performance of the edge nodes at a given level of efficacy and efficiency, even in the face of adverse changes (e.g., failure of an edge node, network interruption). Adverse changes may include the failure of an edge node or the occurrence of a load imbalance among the different edge nodes.

Another technical advantage related to the monitoring, including real-time monitoring, is detecting a change of location of one or more users that are being served by an MLM. The inventive arrangements are capable of reacting to the change in location by redeploying the MLM to one or more other edge nodes to accommodate the user(s) whose location has changed.

If, under certain circumstances, the edge infrastructure does not include an edge node having the processing capabilities needed to run the MLM, then the inventive arrangements provide for deploying or redeploying the MLM to a centralized node, such as a datacenter device (e.g., server) or cloud-based device that is separate from the edge infrastructure and that has a greater amount of processing power than do any of the edge nodes comprising edge infrastructure. A technical advantage of this aspect of deployment and redeployment is that it ensures, or nearly so, that the edge infrastructure is not deprived of the services of an MLM despite the lack of an edge node capable of running the MLM if MLM can be offloaded to a node that is not part of, but communicates with, the edge infrastructure and provides the needed processing power to the edge infrastructure.

In various arrangements, multiple MLMs of various types may be deployed on the edge infrastructure. Applying the same features for deploying one MLM according to the inventive arrangements disclosed herein ensures that the different MLMs are deployed (or redeployed) on edge nodes that are likely ones best suited for running the MLMs. A technical advantage of this aspect of the inventive arrangements is that the resulting deployment (or redeployment) is one in which workloads, latency, and/or energy usage of the edge nodes are likely optimized.

Relying again on the disclosed inventive arrangements pertaining to intermittent or continuous, real-time monitoring, the multiple MLMs may be redeployed in response to detecting a change in processing capabilities of at least one of the edge infrastructure's edge nodes. Again, a technical advantage is the intermittent or continuous, real-time adjusting and, as needed, readjusting of the deployment of MLMs on the edge infrastructure such that workload, latency, and energy efficiency of the edge nodes are likely optimized.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

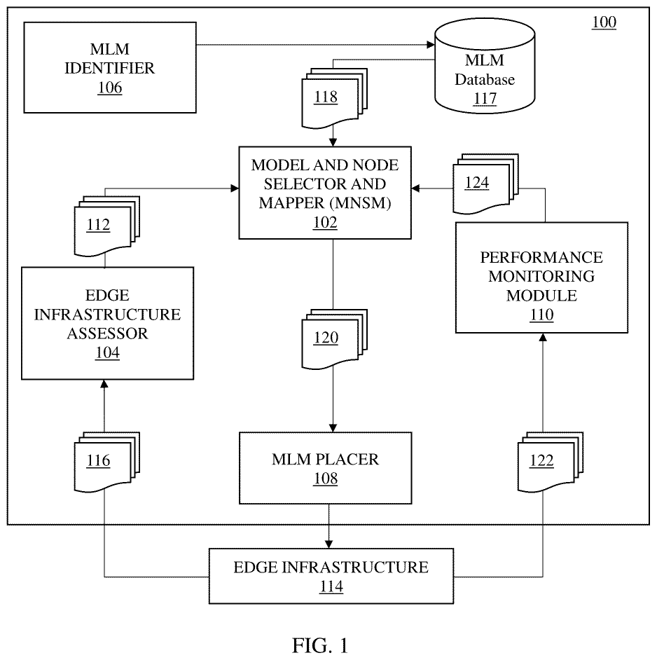

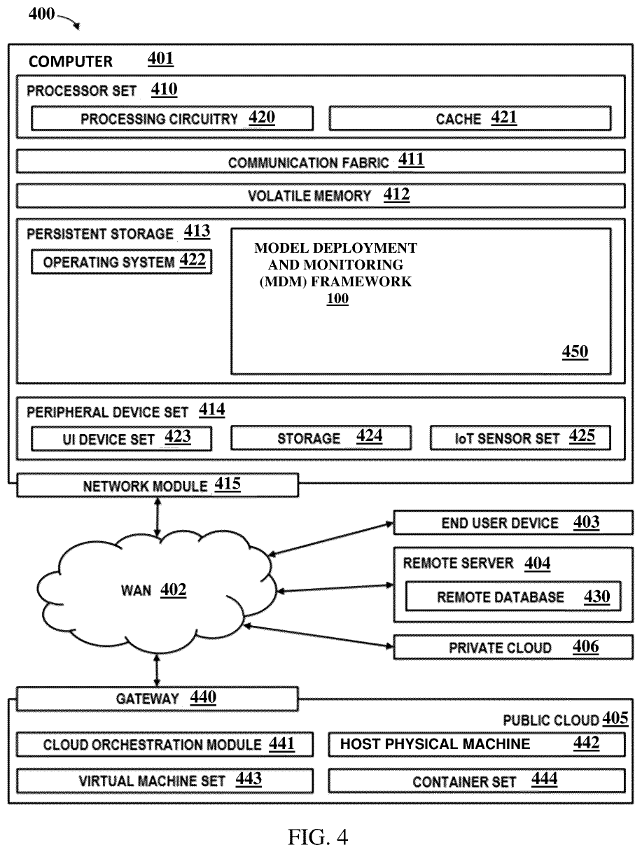

FIG. 1 illustrates an example architecture for an executable model deployment and monitoring (MDM) framework 100, according to an embodiment of the present disclosure. MDM framework 100 is capable of deploying, monitoring, and, as needed, redeploying MLMs, such as an LLM, on edge nodes of an edge infrastructure. In the example architecture of FIG. 1, MDM framework 100 illustratively includes model and node selector and mapper (MNSM) 102, edge infrastructure assessor 104, MLM identifier 106, MLM placer 108, and performance monitor 110. MNSM 102, edge infrastructure assessor 104, MLM identifier 106, MLM placer 108, and performance monitor 110 of MDM framework 100, in certain embodiments, may be implemented in software that is executable on the hardware of one or more computers such as computer 401 (FIG. 4). The one or more computers in which MDM framework 100 is implemented are capable of operatively coupling via a data communication network with the edge nodes that collectively form an edge infrastructure. An edge node may comprise a single computer or multiple computers. Multiple virtual machines may execute on one or more such computers. In some arrangements, an edge node may be implemented in virtual machines executing on a single server or other type of computer.

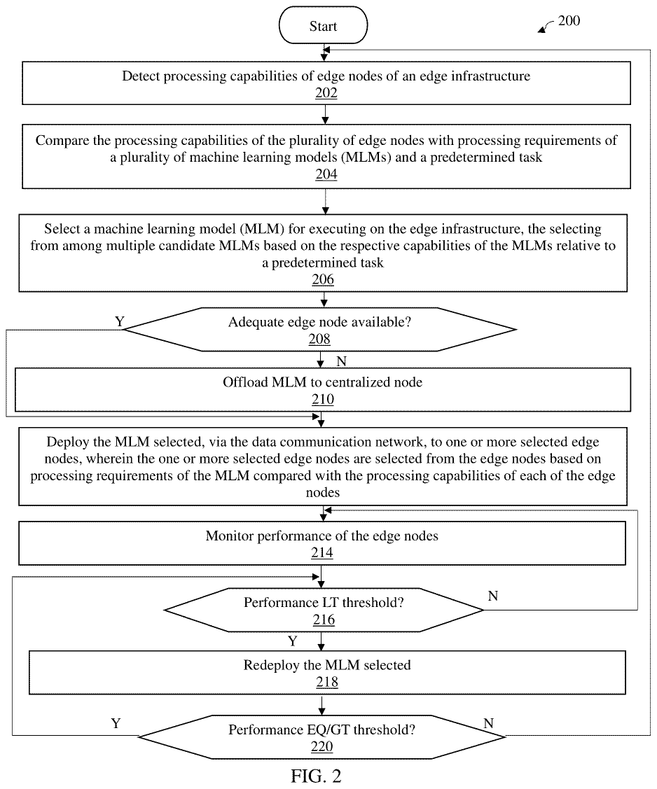

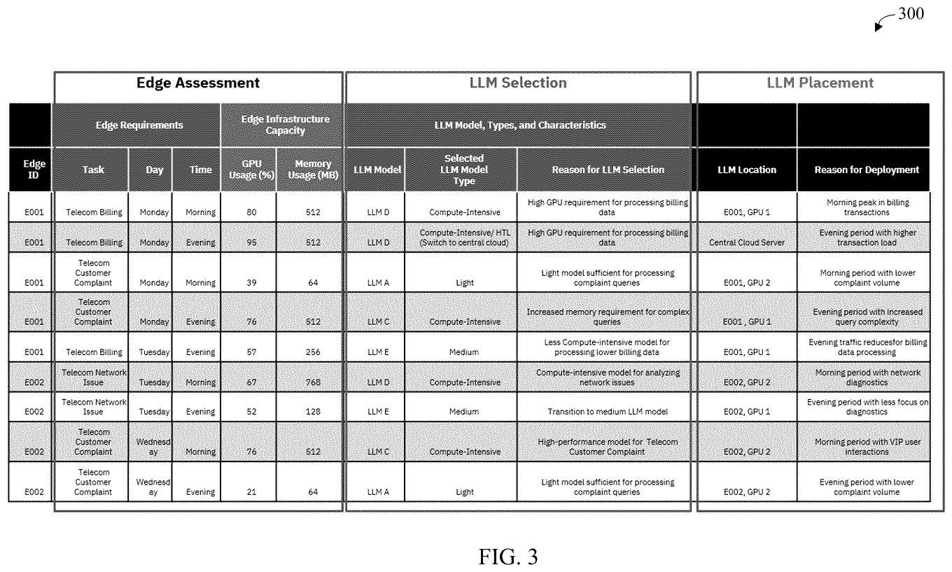

FIG. 2 illustrates an example method 200 of operation of MDM framework 100 of FIG. 1. Referring to FIGS. 1 and 2 collectively, in block 202, MNSM 102 detects the processing capabilities 112 of edge nodes operatively coupled with one another via a data communications network to form edge infrastructure 114. In certain embodiments, MNSM 102 detects processing capabilities 112 as assessed by edge infrastructure assessor 104 based on metrics 116 automatically generated by the edge nodes of edge infrastructure 114 and retrieved by edge infrastructure 114 via a wired or wireless connection. The processing capability of an edge node is determined by the resources the edge node is able to provide for executing an MLM. Metrics 116 may include configuration data pertaining to hardware (e.g., number and type of CPUs and/or GPUs, amount of physical memory) and software (e.g., operating system, other management software, application software), as well as workload data indicating resource availability given current operating conditions (e.g., available CPU (percent), available GPU (percent), available memory (MBs)). Such metrics may be generated automatically by one or more software programs, typically the operating system or other administrative program code, running on the edge nodes. Various operating systems that run on the edge nodes may automatically measure CPU, GPU, memory and/or other resource usages. For example, an operating system may continuously track CPU usage in allocating processing power to various tasks and for load balancing. The operating system, likewise, may monitor memory usage, for example, as well as other resource usages. The resource usage data likely varies depending on the particular task being performed by an edge node, such as executing an application. Moreover, the resource usage data for specific tasks may vary depending on specific conditions under which the edge node performs the tasks. In some arrangements, the specific conditions include the days and times that the tasks are performed (FIG. 3).

In block 204, MNSM 102 compares processing capabilities 112 of the edge nodes of edge infrastructure 114 with the processing requirements of each of a plurality MLMs stored in MLM database 117. The processing requirements of each of the MLMs may vary depending on the complexity of the MLM and the data the MLM processes. An edge node having a GPU, substantial amount of memory, and significant storage capacity may be required to run a deep learning MLM, for example, whereas for a less complex MLM a standard computer may suffice. An LLM, for example, may require a very powerful GPU or server-grade CPU, several hundred gigabytes of memory, and high-speed storage such as a solid-state driver for faster data access and data processing.

In certain embodiments, MLM identifier 106 generates an MLM profile of each MLM stored in MLM database 117. In one or more embodiments, the profiles may be generated manually and stored. Each MLM profile provides data specifying hardware and/or software requirements (e.g., CPU, GPU, memory, operating system) of a corresponding MLM. Each MLM profile may specify a minimum of processing capabilities 112 an edge node needs in terms of the hardware and/or software for achieving an expected level of performance in running the corresponding MLM. For example, in running an MLM, the profile of the MLM may specify the hardware and/or software requirements for achieving a certain level of throughput or processing speed. Thus, each MLM profile may uniquely specify the specific processing requirements of a corresponding MLM. By comparing processing capabilities 112 of an edge node with requirements specified by an MLM profile, MNSM 102 may determine whether the edge node is capable of running the corresponding MLM and with what degree of efficacy and efficiency. As described below, the comparison of MLM processing requirements and processing capabilities 112 is a factor for MNSM 102's decisions about deploying or redeploying an MLM on one or more edge nodes of edge infrastructure 114.

MNSM 102 may also compare processing capabilities 112 of the edge nodes of edge infrastructure 114 as assessed by edge infrastructure assessor 104 with the processing requirements of one or more predetermined tasks that execute on the edge nodes of edge infrastructure 114. The processing requirements for a specific task may also be used by MNSM 102 in deploying or redeploying an MLM on one or more edge nodes of edge infrastructure 114.

In block 206, MNSM 102 selects an MLM for executing on one or more edge nodes of edge infrastructure 114. MNSM 102 selects the MLM from multiple MLM candidates 118 identified by MLM identifier 106 among the MLMs stored in MLM database 117. MLM identifier 106 identifies MLM candidates 118 based on the respective capabilities of the MLMs relative to one or more predetermined tasks. In one or more embodiments, the capabilities of the MLMs may be specified by the respective MLM profiles. The capabilities of MLM candidates 118 are such that they satisfy the requirements for supporting one or more tasks performed on one or more edge nodes of edge infrastructure 114. Thus, the respective capabilities of MLM candidates 118 pertain to the specific task or tasks for which an MLM is sought. Different tasks typically require different MLM capabilities. MNSM 102 selects from among MLM candidates 118 the MLM that is likely to be the best-suited, or nearly optimal, MLM given the specific task. For example, in the context of an edge infrastructure dedicated to telecommunication (telecom) operations, the tasks may include customer billing, answering customer complaints, addressing telecom network issues, and a host of other tasks. Each such task may advantageously utilize a specific type of MLM - namely, an LLM particularly suited for the given task (FIG. 3). Given the availability of variously constructed and trained LLMs, however, it is necessary that MNSM 102 identify which is likely best-suited or approximately optimal for the given task. MNSM 102 selects the MLM from multiple MLM candidates 118 identified by MLM identifier 106 by matching the MLM capabilities to the processing requirements of the predetermined task(s). The predetermined task may be one that is scheduled to occur or be performed on a particular date and time on a particular edge node. For example, the predetermined task may be a task planned for implementation on a particular edge node at a certain date and/or time of day. The predetermined task may be performed or determined, for example, based on historical usage data. The historical usage data reflects user needs to be fulfilled by the edge node proximate to such users.

In block 208, MNSM 102 based on the comparison of the processing capabilities of the edge nodes and the processing requirements of the selected MLM determines whether an edge node of edge infrastructure 114 has the capability to run the MLM.

In block 210, MNSM 102 may detect that no edge node of edge infrastructure 114 has the capability to run the MLM. In response to detecting the condition, MDM framework 100 may offload the MLM to a centralized node (not shown) separate from edge infrastructure 114. The centralized node, for example, may be a cloud-based server or a server of a datacenter that may operatively couple with an edge node but is not part of edge infrastructure 114. A cloud-based or datacenter server or other type of centralized node that is separate from edge infrastructure 114 may be one that has greater processing power than any of the edge nodes that comprise the edge infrastructure.

In block 212 if the MLM is not offloaded, MNSM 102 maps the MLM selected from among MLM candidates 118 to an edge node of edge infrastructure 114. The mapping maps the selected MLM to one or more of the edge nodes of edge infrastructure 114. The mapping is based on MNSM 102's comparing the processing requirements of the selected MLM with processing capabilities 112 of the edge nodes available on edge infrastructure 114. For example, a relatively complex MLM likely requires a different level of processing capability than a relatively less complex MLM. Accordingly, based on processing capabilities 112 of the edge nodes, MNSM 102 generates mapping 120, which maps the selected MLM to one or more edge nodes that are best suited, or likely optimal, for executing the selected MLM. The MLM selected along with mapping 120 are conveyed by MNSM 102 to MLM placer 108. MLM placer 108, following the dictates of mapping 120, deploys selected MLM via the data communication network to the one or more edge nodes to which the selected MLM is mapped.

In certain embodiments, MNSM 102 detects a change in location of one or more users being served by the selected MLM. MNSM 102 reacts by redeploying the selected MLM to one or more other edge nodes to accommodate the user(s) whose location has changed.

In block 214, performance monitor 110 monitors the performances of the edge nodes of edge infrastructure 114. MNSM 102, in certain embodiments, may continuously monitor the edge nodes of edge infrastructure 114 in real time to detect changes in processing capabilities 112 of the edge nodes. The monitoring by MNSM 102, in certain embodiments, may also detect current operating conditions of the data communication network operatively coupling the edge nodes with one another and with MDM framework 100. Network conditions may be detected by MNSM 102 based on network data obtained by edge infrastructure assessor 104. MNSM 102 may detect a deterioration in network performance that may cause an MLM to not function properly or be unable to provide timely information to users. Adverse network conditions that can degrade performance include a network outage or too high a latency due to high congestion, for example.

Performance monitor 110 may monitor the performance intermittently or continuously, in real time. Performance monitor 110 obtains performance data 122 from the edge nodes of edge infrastructure 114 and based on the data determines performances 124 of each edge node. Performance, in various embodiments, is measured by performance monitor 110 according to different measurements. For example, one measure of performance used by performance monitor 110 is the speed by which the tasks executed by the edge nodes, given the deployment of one or more MLMs, are performed. Another performance measure used by performance monitor 110, for example, is the throughput of the edge nodes given the specific deployment. Given that different MLMs that are deployed may each have a distinct minimum set of hardware and/or software requirements (e.g., CPU, GPU, memory, operating system), performance of each may be measured as an expected level of performance in terms of tokens per unit of time or other throughput measure for different hardware and/or software configurations. Accordingly, the performance capabilities associated with the different MLMs may also indicate what percentage of the GPU(s) or other hardware resources of the edge nodes will be consumed by executing a specific MLM. An MLM may be an LLM, in which case, the performance of the LLM may be measured in terms of tokens (e.g., characters, words) processed or streamed per unit of time. Performance of the data communication network that operatively couples the edge nodes of the edge infrastructure may be measured, for example, in terms of latency and/or network congestion that influences the latency. In certain embodiments, an infrastructure-wide measure of performance is Pareto efficiency. The deployment of the MLM(s) on infrastructure 114 is a Pareto-efficient deployment if, and only if, there is no alternative MLM deployment that improves the performance (e.g., execution or throughput) of one edge node without adversely affecting the performance of one or more of the edge infrastructure's other edge nodes.

In block 216, if the performance of the edge nodes of edge infrastructure 114 is less than (LT) a predetermined threshold or otherwise Pareto inefficient, then in block 218 MDM framework 100 responds to the deterioration in performance by redeploying the MLM. The MLM may be redeployed to one or more different edge nodes of edge infrastructure 114 or MLM may be offloaded to a centralized node, such as a centralized cloud server or a server of a datacenter operatively coupled with but not part of the edge infrastructure. MNSM 102 may also replace one MLM with a different one if necessary to maintain or enhance performance of edge infrastructure 114. For example, MNSM 102 may detect that increased network congestion is slowing the execution of an MLM and may react by replacing the MLM with a faster MLM. Thus, if high network congestion cannot be controlled, NSM 102 may select a faster, though less sophisticated MLM to maintain the overall respond time within an acceptable limit.

The MLM may be redeployed to the centralized node in response to detecting that edge infrastructure 114 does not include an edge node having the processing capabilities needed to run the MLM optimally. This may occur if there is no edge node of edge infrastructure 114 capable of running the MLM at all. However, even if one or more edge nodes may be capable of running the MLM, doing so may be sub-optimal. For example, running the MLM on the only edge node capable of running the MLM may preclude the edge node's performing a task having a higher priority. In another example, another edge node capable of running the MLM may be located significantly farther away from the user's being served such that latency of the MLM in providing services to the users is too high. Therefore, MNSM 102 detects the less-than-optimal arrangement and offloads the MLM to the centralized node, thereby freeing the edge node to perform the task having the higher priority.

Different events and/or conditions may cause or contribute to the performance of the edge nodes deteriorating to a performance level less than a predetermined threshold. One event is the failure or deterioration of the performance of the hardware of one or more edge nodes forming edge infrastructure 114. The deterioration of the performance of the hardware may result from a change in conditions resulting from increased processing demands imposed on the edge nodes. Increased processing demand also may result from the introduction of one or more new tasks to be performed by the edge nodes of edge infrastructure 114. Another event causing a performance deterioration is the addition of another MLM on one or more edge nodes.

In block 220, performance monitor 110 determines whether the redeployment of the MLM remedies the deterioration in performance of the edge nodes. Performance monitor 110 determines whether performance of the edge nodes equals or exceeds the threshold following the redeployment. The determination is based on newly generated metrics 116 automatically generated by the physical components of the edge nodes and obtained by edge infrastructure assessor 104.

If redeployment of the MLM fails to improve the performance of the edge nodes, then depending on the reason for the failure, one or more of the operations described with respect to blocks 202-206 may be repeated. Newly generated metrics may be detected and/or one or more MLMs selected anew for deployment on one or more edge nodes. Thus, more generally, MDM framework 100 may intermittently or continuously assess the performance of the edge nodes given an existing deployment of one or more MLMs. In many situations where more than one MLM is deployed on edge infrastructure 114, MDM framework 100 based on detecting the performances of the edge nodes may identify situations where a redeployment is necessary. MDM framework 100 may detect and devise MLM deployments that, given scenarios like diminishing edge node-based resources, nonetheless are ones that are most likely to optimize performance of the edge nodes. In some situations, MDM framework 100 may offload one or more MLMs from the edge infrastructure to a centralized node (e.g., cloud-based server) in response to detecting the opportunity to potentially maximize performance by utilizing the centralized node.

In certain arrangements, the MLM may be one of multiple, different MLMs, each having different characteristics relevant to the operations performed for different tasks. In some embodiments, MNSM 102 is capable of implementing an optimization model for performing a constrained optimization. Processing capabilities 112 of each edge node, determined based on metrics 116 as described above, are input to the optimization model along with data corresponding to the processing requirement of each of the different MLMs. MNSM 102 uses the constrained optimization to allocate each of the different MLMs to specific edge nodes. The deployment may be such that workload, latency, energy efficiency and/or other performance measures for each of the edge nodes is likely optimized.

If a single entity (e.g., enterprise or organization) operates multiple edge infrastructures (FIG. 3), then MNSM 102 may perform the constrained optimization jointly over the different edge infrastructures. Accordingly, tasks performed on edge nodes of each edge infrastructure are assessed along with the processing requirements of the different MLMs such that the different MLMs are optimally allocated with respect to the edge nodes of each of the multiple edge infrastructures. If a change in processing capabilities of at least one of the edge nodes is detected by performance monitor 110, then the multiple MLMs may be redeployed by MNSM 102 according to a constrained optimization such that workload, latency, and/or energy efficiency of the edge nodes of the different edge infrastructures are likely optimized following the redeployment of the multiple MLMs.

FIG. 3 illustrates certain operations 300 performed by MDM framework 100 operating in the context of an edge infrastructure that supports the operations of an example telecom enterprise. The tasks performed by the edge nodes in support of the telecom enterprise include billing customers, handling customer complaints, and addressing network issues. The edge nodes utilize different MLMs in performing the tasks. Each of the MLMs is a distinct LLM, the different LLMs identified as LLM A, LLM C, LLM D, and LLM E. In general, an edge node includes one or more computing devices (e.g., server), which may each include one or more multicore devices that each have more than one CPU or GPU. Illustratively, in FIG. 3, the infrastructure includes edge node E001, GPU 1; edge node E001, GPU 2; edge node E002, GPU 1; and edge node E002, GPU 2. In various arrangements, edge node E001, GPU 1 and edge node E001, GPU 2 may comprise two distinct GPUs of a single multicore device or alternatively separate devices each having a single GPU. Likewise, edge node E002, GPU 1 and edge node E002, GPU 2 may comprise two GPUs of a single multicore device or separate devices each having a single GPU.

With respect to telecom billing, edge infrastructure assessor 104 identifies the task as being performed on Monday mornings, Monday evenings, and Tuesday evenings and assesses usage of infrastructure resources in relation to the task. MNSM 102, based on the assessment, selects LLM D to support both the Monday morning and Monday evening telecom billing. The high GPU requirement (80% GPU usage) prompts MNSM 102 to select edge node E001, GPU 1 for Monday morning telecom billing, and MLM placer 108 deploys LLM D to the edge node. Monday evening telecom billing is even more resource intensive requiring an even higher level of GPU usage (95%), which exceeds the capacity (not shown) of any available edge nodes of the telecom enterprise's edge infrastructure. Accordingly, MNSM 102 halts the running of LLM D for Monday evening telecom billing on edge node E001, GPU 1 and offloads LLM D to a centralized cloud-based server distinct from the edge infrastructure. Edge infrastructure assessor 104 identifies only medium GPU usage (57%) for Tuesday evening telecom billing, and accordingly, MNSM 102 relaces LLM D with LLM E to support the task's lower resource demands, selecting edge node E001, GPU 1 to run the LLM. MLM placer 108 deploys LLM E to edge node E001, GPU 1. LLM E performs the same tasks as LLM D, albeit with lower resource usage than LLM D. Based on historical resource usage data, for example, MNSM 102 may determine that the resource demands for telecom billing on Tuesday evenings (e.g., level of detail of response or the like) is typically lower than on Monday mornings and Monday evenings when the level of resource usage makes it more optimal to utilize LLM D.

MDM framework 100 operates to optimally balance both the load on the edge infrastructure owing to the tasks performed and the resource intensity of each MLM (e.g., LLM) that supports the tasks. With respect to the task of handling telecom customer complaints, for example, edge infrastructure assessor 104 identifies Monday morning and evening and Wednesday morning and evening to perform the task and assesses how resource intensive the MLMs supporting the task are. Monday morning's handling of telecom customer complaints imposes relatively light resource requirements, requiring only 39% GPU usage and 64 MB of memory. MNSM 102, based on the assessment, selects LLM A and MLM placer 108 deploys the model to edge node E001, GPU 2. In contrast to that of Monday morning, Monday evening's handling of telecom customer complaints, as identified by edge infrastructure assessor 104, is significantly more resource intensive, requiring 76% GPU usage and 512 MB of memory. The load of telecom customer complaints, for example, may be ascertained from historical data, which also can indicate the resource intensity or usage of the LLMs that support the task. For example, the intensity may stem from a greater level of detail needed for handling individual telecom customer complaints.

MNSM 102, based on edge infrastructure assessor 104's determination of high resource intensity, selects LLM C in place of LLM A, and MLM placer 108 deploys LLM A to edge node E001, GPU 1. Wednesday morning's handling of telecom customer complaints is likewise resource intensive. Edge infrastructure assessor 104 identifies requirements of 76% GPU usage and 512 MB of memory. MNSM 102 selects LLM C and MLM placer 108 deploys LLM C to E002, GPU 2 to support handling telecom customer complaints, replicating the operations performed in support of Monday evening's handling of telecom customer complaints. Edge infrastructure 104 detects that Wednesday evening's handling of telecom customer complaints is significantly resource intensive than Wednesday morning's handling is. Accordingly, MNSM 102 selects LLM A to replace LLM C, and MLM placer 108 replaces LLM C by deploying LLM A on edge node E002, GPU 2 in its place.

The task of handling network issues is illustratively performed by the telecom enterprise on Tuesday, both Tuesday morning and Tuesday evening. Edge infrastructure assessor 104 identifies that the morning's handling of network issues is resource intensive, requiring 76% GPU usage and 512 MB of memory. MNSM 102 selects LLM C, and MLM placer 108 deploys the LLM to edge node E002, GPU 2. Both the required GPU usage and needed memory for the evening handling of network issues are light. MNSM 102, accordingly, selects LLM A to replace LLM C. In response, MLM placer 108 removes LLM A and deploys LLM C on edge node E002, GPU 2.

The examples are merely illustrative of the different deployments implemented by MDM framework 100 given, for example, the complexities of the MLMs (e.g., LLMs), the nature of the tasks performed with the MLMs, conditions under which the tasks are performed, and the various edge nodes'available resources. MDM framework 100 deploys, monitors, and, as needed redeploys one or more MLMs on edge nodes of one or more edge infrastructures to ensure that the MLMs are deployed in the arrangement that is most likely to optimize resource usage and performance.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 4, computing environment 400 contains an example of an environment for the execution of at least some of the computer code in block 450 involved in performing the inventive methods, such as MDM framework 100 implemented as executable program code or instructions. MDM framework 100 deploys MLMs among edge nodes forming an edge infrastructure. The MLMs may be deployed by MDM framework 100 such that the MLMs are allocated to edge nodes in a manner most likely to optimize workloads, latency, and/or energy efficiency of the edge nodes. MDM framework 100 may monitor the performance of the edge nodes, including in real or near-real time. If MDM framework 100 detects a deterioration in one or more edge nodes'performance, then MDM may redeploy the MLMs in a revised configuration to rectify the deterioration.

Computing environment 400 additionally includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and MDM framework 100, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

Communication fabric 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid-state storage devices. Operating system 422 may take several forms, such as various known proprietary operating systems or open-source Portable Operating System Interface type operating systems that employ a kernel. The code included in block 450 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (e.g., where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer, and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (e.g., embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 403 is any computer system that is used and controlled by an end user (e.g., a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

The terminology used herein is for the purpose of describing particular embodiments only and is not intended to be limiting. Notwithstanding, several definitions that apply throughout this document now will be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
detecting, by computer hardware, processing capabilities of a plurality of edge nodes of an edge infrastructure;
comparing, by the computer hardware, the processing capabilities of the plurality of edge nodes with profiles for a plurality of machine learning models (MLMs) and processing requirements of a predetermined task;
selecting, by the computer hardware, an MLM from the plurality of MLMs for executing on one or more edge nodes of the plurality of edge nodes based on the comparing;
selecting, by the computer hardware, an edge node from the plurality of edge nodes to run the MLM selected based on the comparing; and
deploying, by the computer hardware, via a data communication network, the MLM selected to the edge node selected.

2. The computer-implemented method of claim 1, wherein the detecting the processing capabilities of the plurality of edge nodes and deploying the MLM selected are performed in real time.

3. The computer-implemented method of claim 1, further comprising:
monitoring via the data communication network a performance of the selected edge node in executing the MLM selected; and
redeploying the MLM selected to one or more different nodes in response to detecting that the performance is less than a predetermined threshold.

4. The computer-implemented method of claim 3, wherein the redeploying includes redeploying the MLM selected to a centralized node in response to detecting that the edge infrastructure does not include an edge node having the processing capabilities needed to run the MLM selected optimally.

5. The computer-implemented method of claim 1, wherein the processing capabilities of the plurality of edge nodes include at least one of central processing unit (CPU) availability, graphical processing unit (GPU) availability, and conditions of the data communication network.

6. The computer-implemented method of claim 1, wherein the deploying deploys the MLM selected and others of the plurality of MLMs such that at least one of workload, latency, and energy efficiency of the plurality of edge nodes are likely optimized.

7. The computer-implemented method of claim 6, further comprising:
redeploying the MLM selected with others of the plurality of MLMs in response to detecting a change in processing capabilities of at least one of the plurality of edge nodes, wherein the redeploying is such that at least one of workload, latency, and energy efficiency of the plurality of edge nodes is likely optimized.

8. A system, comprising:
one or more processors capable of initiating operations including:
detecting processing capabilities of a plurality of edge nodes of an edge infrastructure;
comparing the processing capabilities of the plurality of edge nodes with profiles for a plurality of machine learning models (MLMs) and processing requirements of a predetermined task;
selecting an MLM from the plurality of MLMs for executing on one or more edge nodes of the plurality of edge nodes based on the comparing;
selecting an edge node from the plurality of edge nodes to run the MLM selected based on the comparing; and
deploying via a data communication network, the MLM selected to the edge node selected.

9. The system of claim 8, wherein the one or more processors are capable of initiating operations further including:
monitoring via the data communication network a performance of the selected edge node in executing the MLM selected; and
redeploying the MLM selected to one or more different nodes in response to detecting that the performance is less than a predetermined threshold.

10. The system of claim 9, wherein the redeploying includes redeploying the MLM selected to a centralized node in response to detecting that the edge infrastructure does not include an edge node having the processing capabilities needed to run the MLM selected optimally.

11. The system of claim 8, wherein the processing capabilities of the plurality of edge nodes include at least one of central processing unit (CPU) availability, graphical processing unit (GPU) availability, and conditions of the data communication network.

12. The system of claim 8, wherein the deploying deploys the MLM selected and others of the plurality of MLMs such that at least one of workload, latency, and energy efficiency of the plurality of edge nodes are likely optimized.

13. The system of claim 12, wherein the one or more processors are capable of initiating operations further including:
redeploying the MLM selected with others of the plurality of MLMs in response to detecting a change in processing capabilities of at least one of the plurality of edge nodes, wherein the redeploying is such that at least one of workload, latency, and energy efficiency of the plurality of edge nodes is likely optimized.

14. A computer program product, the computer program product comprising:
one or more computer-readable storage media and program instructions collectively stored on the one or more computer-readable storage media, the program instructions executable by a processor to cause the processor to initiate operations including:
detecting processing capabilities of a plurality of edge nodes of an edge infrastructure;
comparing the processing capabilities of the plurality of edge nodes with profiles for a plurality of machine learning models (MLMs) and processing requirements of a predetermined task;
selecting an MLM from the plurality of MLMs for executing on one or more edge nodes of the plurality of edge nodes based on the comparing;
selecting an edge node from the plurality of edge nodes to run the MLM selected based on the comparing; and
deploying via a data communication network, the MLM selected to the edge node selected.

15. The computer program product of claim 14, wherein the detecting the processing capabilities of the plurality of edge nodes and deploying the MLM are performed in real time.

16. The computer program product of claim 14, wherein the program instructions are executable by the processor to cause the processor to initiate operations further including:
monitoring via the data communication network a performance of the selected edge node in executing the MLM; and
redeploying the MLM to one or more different nodes in response to detecting that the performance is less than a predetermined threshold.

17. The computer program product of claim 16, wherein the redeploying includes redeploying the MLM selected to a centralized node in response to detecting that the edge infrastructure does not include an edge node having the processing capabilities needed to run the MLM selected optimally.

18. The computer program product of claim 14, wherein the processing capabilities of the plurality of edge nodes include at least one of central processing unit (CPU) availability, graphical processing unit (GPU) availability, and conditions of the data communication network.

19. The computer program product of claim 14, wherein the deploying deploys the MLM selected and others of the plurality of MLMs such that at least one of workload, latency, and energy efficiency of the plurality of edge nodes are likely optimized.

20. The computer program product of claim 19, wherein the program instructions are executable by the processor to cause the processor to initiate operations further including:
redeploying the MLM selected with others of the plurality of MLMs in response to detecting a change in processing capabilities of at least one of the plurality of edge nodes, wherein the redeploying is such that at least one of workload, latency, and energy efficiency of the plurality of edge nodes is likely optimized.
